(19) United States
(12) Patent Application Publication
(10) Pub. No.: US 2009/0005582 A1
(43) Pub. Date: Jan. 1, 2009

(54) VESSELS AND METHODS FOR SYNTHESIS OF BIOFUEL

(76) Inventor: Greg Anderson, Takaka (NZ)

Correspondence Address: WILSON SONSINI GOODRICH & ROSATI, 650 PAGE MILL ROAD, PALO ALTO, CA, 94304-1050, US

(21) Appl. No.: 12/143,724

(22) Filed: Jun. 20, 2008

Related U.S. Application Data
(60) Provisional application No. 60/945,890, filed on Jun. 22, 2007.

(51) Int. Cl. C11C 3/00; B01J 19/00

(52) U.S. Cl. 554/167; 554/170; 422/202

(57) ABSTRACT

Vessels and methods for esterification and transesterification of fatty acids under near critical or supercritical reaction conditions are disclosed herein. Alkyl esters produced in the vessel with the disclosed methods are used to create biofuel, such as biodiesel.

### CROSS-REFERENCE

This application claims the benefit of U.S. Provisional Application No. 60/945,890 filed Jun. 22, 2007, which application is incorporated herein by reference.

### BACKGROUND OF THE INVENTION

Esterification and transesterification reactions under near-critical and supercritical reaction conditions have been known for some time to produce fatty acid alkyl esters. Using near critical and supercritical reaction conditions, a rapid increase in reaction rate occurs between an alcohol and a fatty acid or an ester thereof. Because of the requisite high temperatures and pressures normally used for such processes, the reaction typically has been performed using either thick-walled stirred batch reactors or long lengths of narrow bore tubing in order to obtain sufficient residence time for the reaction to reach completion.

Unfortunately, when using shorter lengths of larger diameter tubes or cylinders under the near critical and supercritical reaction conditions, it becomes difficult to maintain what is known as uniform plug flow. A phenomenon known as back diffusion can occur readily, which causes localized variations in reactant ratios within the vessel with concomitant yield reduction. Thus, there exists a need for reaction vessels that will maintain uniform plug flow and methods to efficiently and safely perform esterification and transesterification reactions under near critical and supercritical reaction conditions.

### SUMMARY OF THE INVENTION

In an aspect of the invention, a vessel is provided for producing fatty acid esters comprising: a sealable input; a body that surrounds an interior, wherein said body is sufficiently robust to withstand a temperature greater than 200° C. and a pressure greater than 10 mPa; a porous structure that comprises a transition metal or a transition metal oxide or an oxide or silicate of aluminum, magnesium, calcium, or silicon, wherein the porous structure occupies more than half of the volume of said interior; and flow control system comprising a sealable input, wherein an alcohol, with or without a co-solvent, and a lipid-containing substance enter the vessel as a reaction mixture through said input, and an output, wherein alcohol, with or without a co-solvent, glycerol and fatty acid esters exit the vessel as a reaction product.

In one embodiment, a vessel comprises a regulated heater for maintaining said temperature greater than 200° C. In a further embodiment, the temperature can be maintained near or above a supercritical temperature of said reaction mixture.

In another embodiment, a vessel comprises a regulated pumping system for maintaining said pressure greater than 10 mPa. The regulated pumping system can also comprise a back pressure regulating valve. A vessel can further comprise a system for flow control of the substances entering and exiting the vessel.

In a further embodiment, the porous structure within the body of the vessel may be comprised of what is commonly known as reticulated foam or similar structures, wherein a plurality of restrictive pathways exists within a solid, often catalytic, matrix. Such porous structures can also include, but are not limited to aggregations of spheres or microspheres, granules, nanotubes, hollow fibers, configured in such a manner that a high surface area and restrictive flow path is provided.

In yet a further embodiment, the porous structure comprises a transition metal, or an oxide or silicate of a transition metal or an oxide or silicate of aluminum, silicon, magnesium, or calcium.

A co-solvent can also enter the vessel through the input, either separately or in mixture with the lipid feedstock and alcohol. The co-solvent of the embodiments can be selected from a group consisting of carbon dioxide, nitrous oxide, sulfur dioxide, sulfur hexafluoride, alkyl ethers, alkyl esters, dialkylcarbonates, halocarbons, and C1-C12 alkanes.

In an embodiment, pressure is maintained near or above a supercritical pressure of said mixture of alcohol and lipid feedstock, or in the case of added co-solvent, near of above the supercritical pressure of said mixture of alcohol, lipid feedstock, and co-solvent.

The vessel can also further comprise a catalyst, wherein the catalyst can be a transition metal, a transition metal oxide or silicate, or an oxide or silicate of aluminum, silicon, magnesium, or calcium.

In a preferred embodiment, the porous structure within the vessel comprises said catalyst. For example, if the porous structure is a transition metal oxide reticulated foam, the transition metal oxide foam itself can act as a catalyst. In another example, the porous structure can be coated or infused with a catalyst. In an alternative embodiment, the catalyst can be introduced into the vessel containing a porous structure through said input.

The reaction vessel may be cylindrical in shape. For example, the vessel can be about 10-2000 cm in length and have an inner diameter of about 1-200 cm. In another example, the body is about 30-200 cm in length and has an inner diameter of about 5-30 cm. In another embodiment, the vessel may have a variety of length to width ratios ranging from approximately 50:1 to about 3:1, preferably 20:1 to about 3:1, and more preferably 15:1 to about 3:1 for some applications.

In another aspect of the invention, a method of acquiring fatty acid esters comprises: introducing an alcohol and a lipid-containing substance into a vessel, with or without the aforementioned co-solvent, wherein the vessel is at least 2 cm in inner diameter and wherein the length-to-width ratio of the vessel is less than 50:1; maintaining said vessel at or near the supercritical conditions of said alcohol and reaction mixture, wherein said supercritical conditions react the alcohol and lipid-containing substance to form glycerol and fatty acid esters; and acquiring said fatty acid esters.

In some embodiments, the lipid-containing substance is a fatty acid or a fatty acid ester. A lipid-containing substance can be a waste oil, vegetable oil, animal oil, or animal fat.

In yet another aspect of the invention, methods are provided of producing fatty acid esters which may comprise one or more of the following steps: reacting an lipid-containing substance with an alcohol, with or without the aforementioned co-solvent, in a reaction vessel under near-critical or supercritical reaction conditions, wherein said reaction vessel comprises: a sealable input; a body that surrounds an interior, wherein said body is sufficiently robust to withstand a temperature greater than 200° C. and a pressure greater than 10 mPa; a porous structure that comprises a transition metal, wherein the porous structure occupies more than half of said interior; and a sealable output, wherein an alcohol and a lipid-containing substance enter the vessel through said input and wherein glycerol and fatty acid esters exit the vessel through said output; and producing fatty acid esters from substances exiting the output of the vessel.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 demonstrates an exemplary flow chart of the methods of the invention.

FIG. 2 illustrates an exemplary vessel of the invention comprising a porous structure.

FIG. 3 demonstrates an exemplary batch system of vessels for generating fatty acid esters.

FIG. 4 is a schematic view of an exemplary method of producing and purifying fatty acid esters as biofuel.

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

According to one aspect of the present invention, it would be desirable to manufacture batch and continuous flow reaction vessels without the need for excessive lengths of narrow tubing with its multiplicity of weldments and fittings. However, a problem encountered when using larger diameter reaction vessels under near-critical or supercritical conditions is the necessity for rather thick vessel walls in order to safely contain the required operational pressures. Thus, one would have to conduct the reaction under as low a pressure as possible in the interest of both safety and economy of materials.

It is desirable to manufacture continuous flow reaction vessels sufficiently robust for the conditions used in the supercritical or near-critical production of fatty acid esters. Typically, long and small diameter vessels, often with length/diameter ratios of greater than 50 to 1 and diameters less than 2 cm have been used for supercritical transesterification reactions because of flow and mass transfer problems involved in the use of shorter, larger diameter vessels.

However, these narrow tubular reactors often have a multiplicity of weldments and fittings due to the length, which commonly exceed 30 meters. This length is necessary in narrow tube reactors to ensure the requisite mixing action, uniformity of flow, and the residence time necessary for reasonable yields of ester products.

As described herein, an aspect of the invention provides innovative solutions to such problems by providing reaction vessels with specially shaped or preformed internal surfaces for the production of fatty acid alkyl esters under near-critical and/or supercritical reaction conditions. In these embodiments, the specially-shaped internal surfaces can be porous surfaces, such as a foam or formed with a foamed material. Preferably the reaction vessel incorporates a porous structure as a specially shaped catalytic surface. In an alternative embodiment, the internal surfaces can provide a surface for the coating of infusion of a catalyst of a reaction to be carried out within the vessel. By incorporating these materials in accordance with this concept of the invention, a reaction vessel may be configured and possess a much or relatively smaller length to diameter ratios, and often substantially lower operating conditions of temperature and pressure can be realized. Additionally, shorter vessels of larger relative diameter are typically easier to fabricate, and at lower cost. The incorporation of the porous materials in preferable embodiments of the invention also allows for the improvement of product yields compared to operation of the vessels without inclusion of these materials.

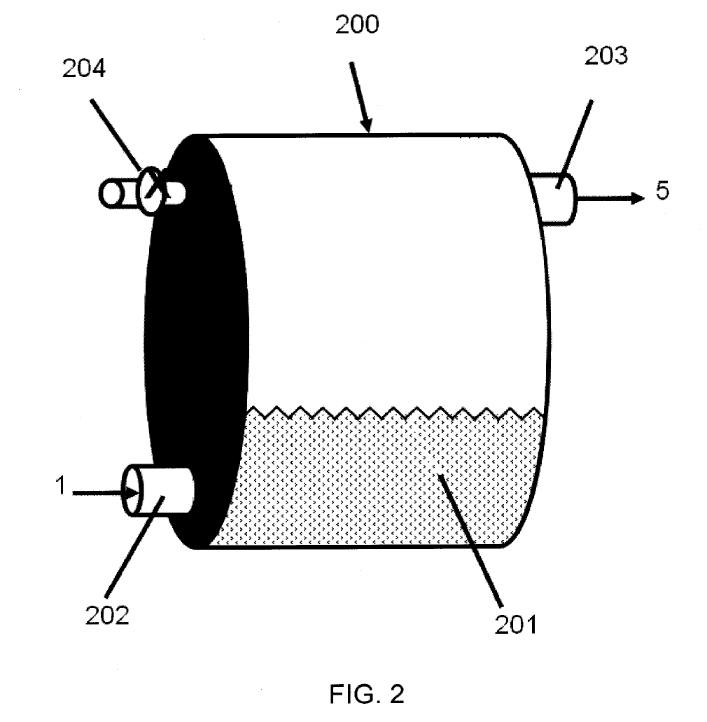

FIG. 2 demonstrates an exemplary vessel of the invention. A vessel 200 is provided for producing fatty acid esters. The body of the vessel may be formed with a cylindrical shape sufficiently robust to withstand temperatures greater than 200° C. and pressures greater than 10 mPa. The body of the vessel surrounds an interior comprising a porous structure 201 that may occupy up to or more than half of the volume of said interior. For certain applications, the porous structure may be constructed or formed to occupy up to 10%, 20%, 30%, or 40% of the volume, inclusive of the void volume, of vessel interior, or more preferably up to 50%, 60%, 70%, 80%, 90%, or 100% of the volume, inclusive of the void volume, of the vessel interior. In a preferred embodiment of the invention, the porous structure may introduce turbulent flow to the reaction mixture within the vessel. In another embodiment, the porous structure may further comprise a transition metal, an oxide or silicate of a transition metal or an oxide or silicate of aluminum, silicon, magnesium, or calcium. The vessel also comprises a sealable input 202 for entering the reactants 1 into the vessel, and an output 203 for retrieving the reaction products 5, such as fatty acid esters. The vessel may further comprise a regulator 204 to regulate the pressure within the vessel. For example the regulator can be a valve or any other pressure regulator as would be known to one skilled in the art.

In a preferable embodiment of the invention, the vessel can be cylindrical in shape, about 10-2000 cm in length and have an inner diameter of about 1-200 cm. In another embodiment, the body is about 30-200 cm in length and has an inner diameter about 5-30 cm. In one embodiment, the vessel has a length to width ratio of 50:1 to about 3:1, preferably 20:1 to about 3:1, and more preferably 15:1 to about 3:1. Also, the vessel wall may be 0.1 to 10 cm in thickness, depending on the pressure within the vessel used or required to maintain near-critical or supercritical reaction conditions.

The vessel may be constructed from a material wherein the material is metal, ceramic, glass or plastic or a combination thereof. Examples of metals that can be used include, but are not limited to, steel, stainless steel, copper, titanium, aluminum, and various alloys of half-alloys containing nickel, chromium, molybdenum, titanium, or iron known to be suitable for processes of this nature. In an embodiment, the body of a vessel of the invention comprises stainless steel or a nickel alloy. Preferably the body of the vessel is able to withstand supercritical reaction conditions, for example, temperatures greater than 200° C. and pressures greater than 10 mPa. The body of the vessel can be lined with glass, plastic or a suitable polymeric substance to prevent corrosion.

In a preferred embodiment, the reaction vessel may incorporate a porous structure as a specially shaped internal surface. The porous structures possess high surface to volume ratios, and provide for low pressure drop at high flow velocities, and improved convective heat transfer. The porous structures enhance mixing of the reactants and uniformity of temperature, and reduce the residence time needed to attain the desired yield of ester products. Uniform flow conditions are readily achieved and back-diffusion phenomena are minimized. Without such a structure in a large diameter vessel, areas of back-diffusion and stagnation can occur, which lowers the efficiency of the supercritical transesterification reaction. Additionally, the porous structures can act catalytically to provide high activity with low diffusion resistance. The structures present a large surface area for catalytic activity without the penalty of significantly increased pressure drop, which is commonly encountered with catalysts in a granular or particulate form.

In a further embodiment, the porous structure can comprise a “reticulated foam” type structure, produced from a transition metal or a transition metal oxide or silicate, or an oxide or silicate of aluminum, silicon, magnesium, or calcium. The reticulated foam can be manufactured by conventional means from a readily available substrate such as reticulated polyurethane foam. For example, to manufacture a transition metal reticulated foam, a polyurethane foam structure can be coated, often by means of a slurry in liquid, with a layer of finely divided transition metal. The foam can be put in an oven at a temperature sufficient to vaporize the polyurethane, leaving a transition metal foam. In this case, the metal foam would constitute what is referred to as a “positive” reproduction of the polymer substrate morphology. Alternatively, and especially practical when desiring to produce a foam with increased mechanical strength, the polymeric foam substrate can be “loaded” with a slurry of the desired material, such as a transition metal or a metal oxide slurry, in order to fill the open voids. The original polymeric foam substrate is then pyrolyzed in an oven, leaving a “negative” reproduction of the original polymeric foam substrate. By varying the nature of the polymeric substrate, as well as the slurry density, viscosity, and technique of application, a wide range of porous structures can be produced. These structures will vary in morphology, physical attributes, unit surface area, porosity, catalytic effectiveness, and longevity of function. Any of the aforementioned transition metals, their oxides or silicates, or the oxides or silicates of aluminum, silicon, magnesium, and calcium can be formed into porous structures of this sort.

Other methods of creating and obtaining porous materials such as reticulated foam are well known to those skilled in the art and include, but are not limited to, expanding gas foaming, chemical vapor deposition, powder coating, porous sintering, electroplating, spray coating, and “electroless” plating. Typical examples of commercially available reticulated materials are the nickel foams known as Metpore (produced by Porvair Advanced Materials of Henderson, N.C.) and Incofoam (produced by Inco Specialty Products of Mississauga, Ontario, Canada). Commercially available ceramic foams, composed of such materials as aluminum oxide, silicon carbide and zirconium oxide are also available from a number of suppliers, such as High-Tech Ceramics, Albert, N.Y., and ERG Aerospace, Oakland, Calif. In another embodiment, a finely structured porous material can be manufactured by utilizing a technique known as hetero-coagulation of template/particle colloidal processing. In this method, the electrostatic interactions between nanoparticles in a slurry with polymeric spheres and rods is utilized to obtain, after filtration, a material which can be calcined to obtain a porous structure of tunable and uniform structure. For example, when a slurry of Yttrium/Zirconium oxide 30 nm particles is blended with a slurry of 1.3 μm polymethylmethacrylate (template) particles, and the resulting agglomeration filtered and calcined, a porous structure is obtained consisting of webs of catalytic yttrium/zirconium oxide nanoparticles with 1 μm diameter interconnecting pores. This porous material possesses high surface area, good catalytic activity and low resistance to flow and is very suitable for use in the reaction vessel of the invention. As can be imagined by one skilled in the art, there are many various permutations of this process that will allow for the creation of a plethora of porous materials suitable for incorporation into the reaction vessel of the invention.

The porous structures described herein may provide turbulent and non-stagnating flow through a reactor or reaction vessel, as well as high surface area for catalytic activity, without the penalty of significantly increased pressure drop during transit of the reactants through the reaction vessel. The porous structure itself can act as a catalyst for a transesterification reaction within the vessel. In an embodiment, the porosity of the reticulated foam is between 5 and 200 pores per cm of width. In an embodiment, the foam is a ceramic foam coated with a transition metal oxide or oxide of aluminum, magnesium or calcium. If necessary, a porous structure within the vessel, for example reticulated foam, if fouled, can be cleaned or regenerated by running air or oxygen through the vessel at a high temperature, such as temperatures between 150 and 800 degrees Celsius.

In another embodiment, the porous structure comprises, or is coated with, a reaction catalyst, such as a transition metal or an oxide or silicate thereof, or an oxide or silicate of aluminum, magnesium, silicon, or calcium. One material can be used as the supporting porous structure, and it can be coated with a layer of a second material, possibly possessing enhanced catalytic effect. For example, a stainless steel or nickel porous structure can be coated with a layer of zirconium oxide nanoparticles, which possess catalytic activity for transesterification reactions.

Other aspects of the invention contemplates methods of producing fatty acid esters using one or more embodiments of the vessels disclosed herein and maintaining a reaction between lipid-containing substance, such as oil and/or fat and/or fatty acid, and an alcohol and/or co-solvent at or near supercritical reaction conditions.

The supercritical reaction conditions referred to herein may refer to the following. Fluids in the supercritical condition show a behavior different from the normal states of liquid or gas. A fluid in the supercritical condition is a non-liquid solvent having a density approximate to that of liquid, a viscosity approximate to that of gas, and a thermal conductivity and a diffusion coefficient which are intervenient between those of gas and of liquid. Its low viscosity and high diffusion favor mass transfer therein, and its high thermal conductivity enables high thermal transmission. Because of such a special condition, the reactivity in the supercritical condition is higher than that in the normal gaseous or liquid state and thus esterification and/or transesterification is promoted. One of the most important properties of supercritical fluids is their solvating properties, which are a complex function of their pressure and temperature, independent of their density.

The near-critical condition referred to herein refers to conditions with close proximity to the supercritical conditions.

In most embodiments, the temperature of the supercritical reaction conditions is between 200 and 450 degrees Celsius and the pressure is between 5 and 40 mPa.

A supercritical reaction condition comprises either the lipid-containing substance or alcohol in a supercritical condition. In an embodiment of the invention, the mixture of these components is in a near-critical or supercritical condition. In alternative embodiments of the invention described herein, an additional solvent may be included with the reaction mixture within the reaction vessel and can be in a near-critical or supercritical condition. An additional solvent, or co-solvent, can often lower the temperature and pressure needed to make the reaction enter the supercritical reaction conditions. Examples of the additional solvent include, but are not limited to, carbon dioxide, sulfur dioxide, nitrous oxide, C1-C12 alkanes, ethers, esters, dialkyl carbonates, halogenated hydrocarbons, and other gases or fluids typically used to enhance the rate of reaction.

When a transition metal solid catalyst is used in the present invention, it is preferred to conduct the reaction under conditions in which the oil or fat and/or the alcohol and/or solvent mixture are in a supercritical condition. The vessel can also further comprise a catalyst, wherein the catalyst can be a transition metal, a transition metal oxide or silicate, or an oxide or silicate of aluminum, silicon, magnesium, or calcium.

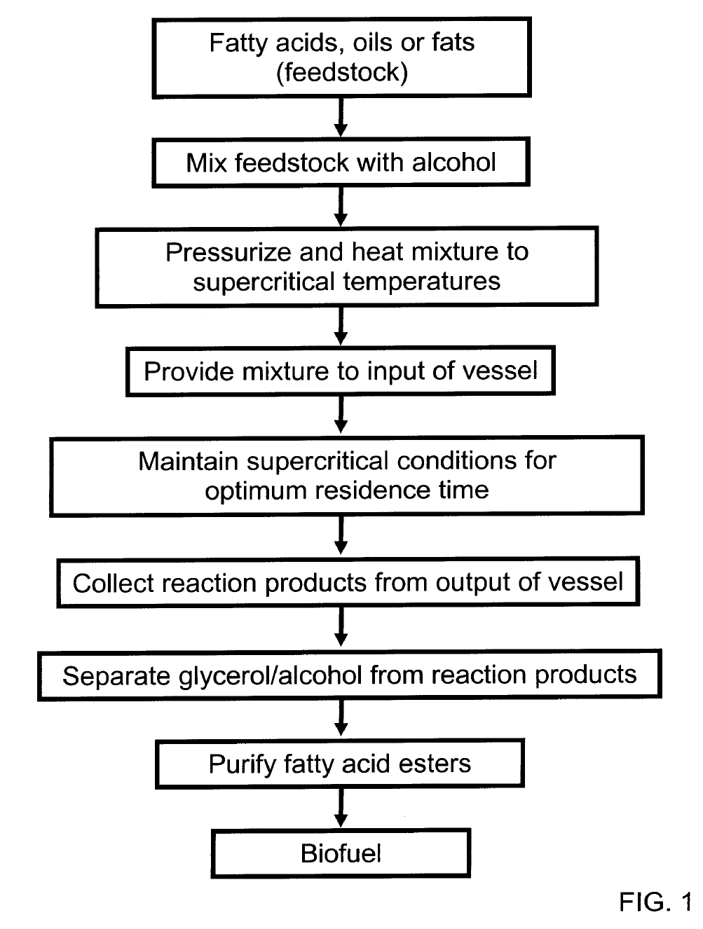

FIG. 1 provides a flow chart of an exemplary method of producing fatty acid ester biofuel utilizing a vessel of the invention. The methods and procedures to make such fatty ester biofuels are known to those of skill in the art and can be readily applied to the concepts of the invention such as those described in U.S. application Ser. No. 12/143,706, incorporated herein by reference in its entirety. Fatty acids, oils or fats are collected as starting material feedstock for the reaction. The feedstock is mixed with an alcohol and, optionally, other solvents such as fluids or gases to create the reaction mixture. The reaction mixture is pressurized and pre-heated and then introduced into the reaction vessel through a sealable input. The vessel and its contents are adjusted to maintain near-critical of supercritical conditions by pressure and temperature control devices configured and operably coupled to the vessel. Said devices are capable of being regulated to maintain optimum pressure and temperature conditions for the particular reaction mixture in the vessel for the residence time needed to effect the esterification or transesterification reaction, for example 2 to 30 minutes. After the reaction is complete, in a batch mode, or is effected, in a continuous flow mode, the reaction products are collected through the output. The reaction glycerol and alcohol is separated from product fatty acids, with the alcohol being recycled for re-use. The glycerol can be removed by any method as would be known to one skilled in the art, such as decantation, centrifugation, or coalescing separation, leaving a collection of fatty acid esters and reaction intermediates. The reaction product is purified to obtain the fatty acid esters, which can be used as, or mixed with biofuel.

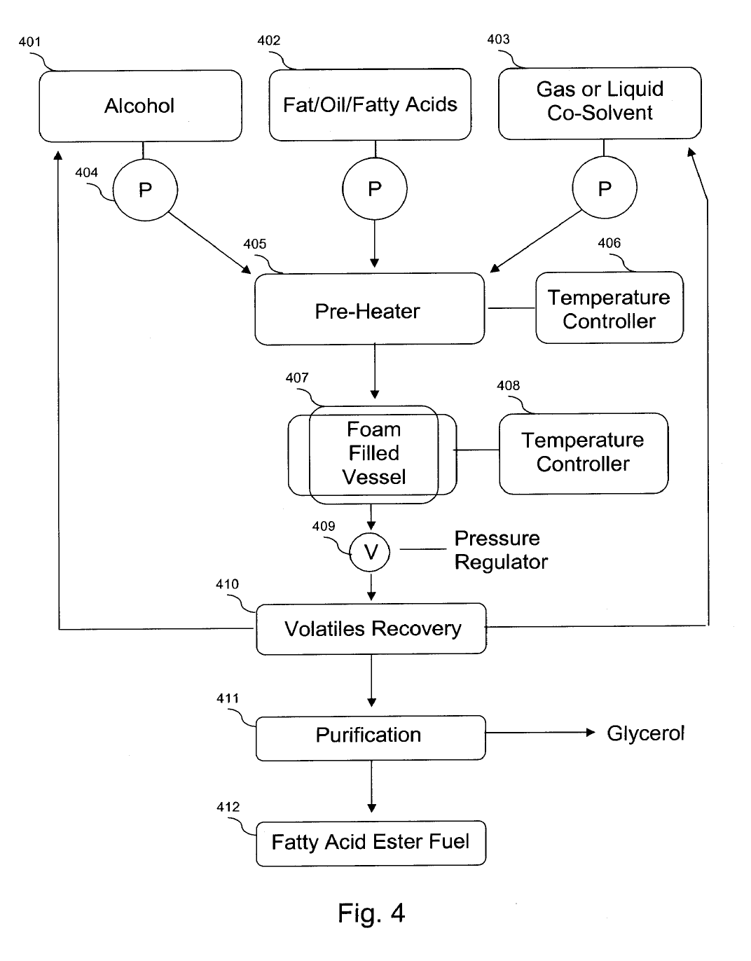

FIG. 4 is a schematic view of an exemplary method of producing and purifying fatty acid esters as biofuel using a vessel and system of the invention. A lipid-containing substance 402, for example chicken tallow, is pumped 404 into the pre-heater device 405. Alcohol 401 and, if desired, a gaseous or liquid co-solvent 403, are also conveniently heated in the pre-heater device. These reaction components can be blended immediately before the pre-heater device, or can be optionally blended within or after the pre-heat device. The temperature of the pre-heat device is regulated by the temperature controller 406, such that a temperature approaching the desired reaction temperature is achieved before the mixture is admitted to the reaction vessel 407. The lipid-containing substance, the alcohol and the co-solvent, if employed, or a mixture of these components can be in a sub-critical, near critical or at a supercritical condition before entering the reaction vessel. The vessel 407 may be maintained, using a temperature controller 406 and a pressure regulator 409, at supercritical or near-critical conditions for the required residence time for conversion of the input reactants into product. The vessel can comprise a porous structure which can optionally comprise a transition metal, an oxide or silicate of a transition metal or an oxide or silicate of aluminum, silicon, magnesium, or calcium.

A transition metal, and/or the aforementioned catalytic oxides or silicates may provide a catalytic surface for the supercritical transesterification reaction. After sufficient residence time in the vessel, for example 2 to 30 minutes, the volatilies; e.g., alcohol and optional co-solvents, can be recovered 410 for re-use in the system. The remaining reaction mixture is then purified 411 and the glycerol can be removed by any method as would be known to one skilled in the art, such as decantation, centrifugation, adsorption, or coalescing separation, leaving a collection of fatty acid esters. As is known to those skilled in the art, operation of the reaction between the alcohol and the lipid feedstock at temperatures above 450° Celsius can result in degradation of the glycerol into simpler, often gaseous compounds, whereby little or no glycerol would be expected at the outlet of the reaction vessel. The fatty acid esters 412 can optionally be used in the creation of biofuels, in particular, biodiesel fuel.

Accordingly, the methods and systems of the invention provide vessels and devices to maintain the temperature and pressure within controlled limits. In one embodiment, the vessel comprises a regulated heater for maintaining a temperature greater than 200° C., for example, near or above a supercritical temperature of a mixture of an alcohol and lipid-containing substance, with or without a co-solvent. In a further embodiment, the vessel comprises a regulated pumping system for maintaining said pressure greater than 10 mPa and can also comprise a back pressure regulating valve.

An embodiment of the invention incorporates an input or output to the reaction vessel or a combination thereof for adding reactants, for example, lipid-containing substances, alcohol, co-solvent, or catalyst, or removing products from a reaction within the vessel. The input and output can be sealable in order to allow the vessel to be heated and pressured to near-critical or supercritical conditions.

A vessel or system of the invention can comprise a compressor or pump to generate pressures with the vessel. For example, the pressure within the vessel may be between 5 and 50 mPa. The pressure within the vessel can be set as to provide a pressure at which the mixture of lipid containing substance, alcohol and/or co-solvent is in a supercritical state. The vessel may also comprise a valve for regulating the pressure within the vessel. Further embodiments of the invention comprise a system for heating the vessel and/or a system for controlling the flow rates of reactants. A heater or system for heating the vessel can be part of the vessel or a system that heats air or the reactants being entered into the reaction vessel. In an embodiment, a heater provides temperatures of greater than 200° C. within the vessel.

In one embodiment, a porous structure occupies greater than half of the interior of the body of a vessel. In another embodiment, the porous structure nearly or completely fills the interior of the body. The porous structure can be fixed to the body of the vessel by friction, adhesion, welding, or clamping. Alternatively the porous structure is not affixed to the body of the vessel. In another embodiment, the porous structure consists of a series of thin porous structures throughout the vessel, which may be separated by baffles or plates. The porous structures are spaced within the vessel to create turbulent flow. In this example, the porous structure occupies less than half of the interior of the body of the vessel.

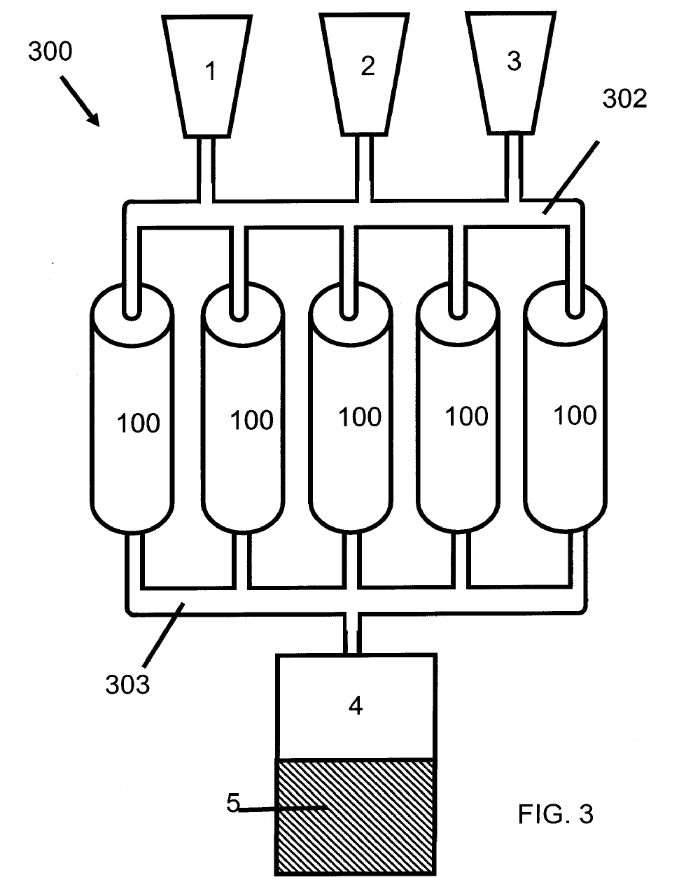

The reactions described herein can be carried out in various reaction modes. For example, the reaction may be carried out in a single vessel, or in a plurality of vessels, which may be connected in series, or operated simultaneously in a parallel array. FIG. 3 demonstrates an exemplary batch system 300 of vessels 100 connected in parallel for generating fatty acid esters. The system comprises a source of a lipid-containing substance 1, a source of an alcohol 2, and optionally a source of a co-solvent or catalyst 3. The batch system can have individual inputs 302 and outputs 303 to each vessel or a common system input 302 or output 303 as shown. The system can comprise a system or device for collecting the reaction products, glycerol 4 and fatty acid esters 5, from the batch reactors 300.

Typical examples of a lipid-containing substance used in the esterification or transesterification reaction include, but are not limited to, tallow of livestock such as lard tallow, chicken tallow, lamb tallow, butter fat, beef tallow, cocoa butter fat, corn oil, peanut oil, cotton seed oil, soybean oil, rapeseed oil, coconut butter, olive oil, safflower oil, coconut oil, oak oil, almond oil, apricot kernel oil, beef bone fat, walnut oil, castor oil, chaulmoogra oil, Chinese vegetable tallow, cod liver oil, cotton seed stearin, sesame oil, deer tallow, dolphin tallow, sardine oil, mackerel oil, horse fat, pork tallow, bone oil, linseed oil, mutton tallow, neat's foot oil, palm oil, palm kernel oil, porpoise oil, shark oil, sperm whale oil, tung oil, whale oil, agricultural crops, crop residues, grain processing facility waste, value-added agricultural facility byproducts, livestock production facility waste, livestock processing facility waste and food processing facility waste. In addition, the lipid-containing substance may be a mixture of plurality of these oils or fats, oil or fat containing a diglyceride or a monoglyceride, or a partly denatured oil or fat such as oxidized, reduced or others. Furthermore, it may be an unpurified oil or fat containing a free fatty acid, water or other, or waste oil or fat discarded by restaurant, food industries or common homes. It is preferred that an appropriate pre-treatment is applied as required.

When substances described herein contained in the lipid-containing substance have a possibility of participating in the reaction, for example, have a possibility of inhibiting the reaction, or they are solid and have a possibility of occluding in the process of production or other similar possibility, it can be preferable to remove them by a treatment such as filtration, distillation or the like before the reaction.

In some embodiments of the invention, waste oils or fats and waste edible oils or fats can also be used as the lipid-containing substance. Agricultural facility byproducts, livestock production facility waste, livestock processing facility waste and food processing facility waste are also utilized as sources of fatty acids or oil-based substances.

The lipid-containing substance acid is reacted with an alcohol to produce a fatty acid ester. Examples of alcohols useful for the reaction include, but are not limited to, methanol, ethanol, n-propanol, isopropanol, n-butanol, isobutanol, t-butanol, pentanol, hexanol, cyclohexanol, heptanol and the like. In preferred embodiments, the alcohol is methanol or ethanol.

Representative fatty acid esters producible by the method of the current invention include, but are not limited to, esters of valeric acid, caproic acid, enanthoic acid, caprylic acid, pelargonic acid, capric acid, undecylic acid, lauric acid, tridecylic acid, myristic acid, pentadecylic acid, palmitic acid, heptedecylic acid, stearic acid, nonadecanoic acid, arachic acid, behenic acid, lignoceric acid, cerotic acid, heptacosanoic acid, montanic acid, melissic acid, lacceric acid, crotonic acid, isocrotonic acid, undecylenic acid, oleic acid, elaidic acid, cetoleic acid, erucic acid, brassidic acid, sorbic acid, linoleic acid, linolenic acid, arachidonic acid, propiolic acid, stearolic acid, nervonic acid, ricinoleic acid, (+)-hydnocarpic acid, (+)-chaulmoogric acid and the like. The character of the resulting esters depends on the alcohol used. For example, a methyl ester is obtained when methanol is used as the alcohol, and an ethyl ester is obtained when ethanol is used as the alcohol.

The fatty acid ester produced by the methods described herein can be used in fuels such as a fuel for diesel engine, a base oil for lubricant oil, an additive for fuel oil and the like by itself or in admixture with other components according to the requirements derived from the use.

A further embodiment of the invention contemplates a method of generating a biofuel, such as biodiesel, from fatty acid esters produced in one or more embodiments of the vessel disclosed herein.

Examples of fatty acid esters for use in biofuel for diesel engine include, but are not limited to, fatty acid methyl ester, fatty acid ethyl ester, fatty acid isopropyl ester, fatty acid isobutyl ester and the like.

The biofuel production vessel and methods described herein provide an economical and environmentally-friendly means of handling wastes such as agricultural facility byproducts, livestock production facility waste, livestock processing facility waste and food processing facility waste, while producing a renewable energy source at the same time. This renewable energy source can be used as a process load. In one embodiment, energy is generated in quantities sufficient to meet the steam load of a processing plant after start-up, without the need for any added auxiliary fuel. The energy produced can additionally or alternately be commercially sold and/or used to generate electricity. Alternatively, some or all of the biofuel, can be sold, thus providing operational flexibility.

In another aspect of the invention, a method of acquiring fatty acid esters comprises: introducing an alcohol and a lipid-containing substance into a vessel, with or without additional co-solvent, wherein the vessel is at least 2 cm in inner diameter and wherein the length-to-width ratio of the vessel is less than 50 to 1; maintaining said vessel at or near the supercritical conditions of said mixture, wherein said supercritical conditions react the alcohol and lipid-containing substance to form glycerol and fatty acid esters; and acquiring said fatty acid esters.

A preferable method of the invention can comprise the step of combining a lipid-containing substance and an alcohol within a vessel provided in accordance with other aspects of the invention at supercritical reaction conditions and recovering fatty acid esters and glycerol from the reaction. A co-solvent and/or catalyst can also be used with a method and vessel of the invention. A system of the invention may comprise some or all of the following: a feedstock tank containing a lipid-containing substance, an alcohol source, a source of co-solvent, pumps and plumbing for transferring reactants, a vessel of the invention, a solvent and alcohol recovery system, a recovery tank containing fatty acid esters and glycerol, a glycerol separation device, a purification column, a pressure control system, a temperature control system, a separation system to remove the glycerol, and a computer control system to control any process of the devices or systems.

In yet another aspect of the invention, a method is provided of producing fatty acid esters comprising: reacting an lipid-containing substance with an alcohol, with or without a co-solvent, in a reaction vessel under near critical or supercritical reaction conditions, wherein said reaction vessel comprises: a sealable input; a body that surrounds an interior, wherein said body is robust at a temperature greater than 200° C. and a pressure greater than 5 mPa; a porous structure that comprises a transition metal, transition metal oxide or silicate, or an oxide or silicate of aluminum, silicon, magnesium or calcium, wherein the porous structure occupies more than half of said interior; and a sealable output, wherein an alcohol, optionally with a co-solvent, and a lipid-containing substance enter the vessel through said input and wherein glycerol, fatty acid esters, along with excess alcohol, and possibly co-solvent, exit the vessel through said output; and producing fatty acid esters from substances exiting the output of the vessel.

The invention may be better understood with reference to the following examples. These examples are intended to be representative of specific embodiments of the invention, and are not intended as limiting the scope of the invention.

### EXAMPLE 1

As an exemplary demonstration, a steel cylinder (2 cm inside diameter, 40 cm length, and 1 cm wall thickness) was used as a reaction vessel. The vessel was maintained at 310 degrees Celsius while a stream consisting of a 1:1 volume ratio of methanol and rapeseed oil was pumped through the cylinder. The flow rate was adjusted in order for the material to remain in the cylinder for a period of 8 minutes before exiting through a back-pressure regulator valve. This valve was adjusted to maintain a system pressure of about 17.65 mPa.

A sample of the product exiting the cylinder was silated using a 9:3:1 solution of pyridine:hexamethyldisilazane:timethylchlorosilane (30 minutes, 75° C.) then was analyzed on a HP 1 silicone column in a 6890 HP Agilent GCMS chromatograph system. Results indicated that less than 70% of the oil had undergone the desired transesterification reaction to become fatty acid methyl esters.

The reaction was repeated, but in this case the cylinder was filled with a 60 pore per inch reticulated nickel foam, which was manufactured by conventional means from reticulated polyurethane foam substrate. The foam had been coated with a nickel slurry, then pyrolyzed, resulting in a highly porous material possessing a large active surface area. The material known as Metpore (produced by Porvair Advanced Materials) was used for this experiment. The nickel catalyst had been partially oxidized by heat treatment in air (800° C. until uniform color change)

The reactant mixture was again pumped through the vessel under conditions identical to the conditions described above in the first experiment. Under these conditions, the product stream analysis indicated that over 90% of the oil had been converted to the desired ester mixture.

These experiments demonstrated that an embodiment of the present invention, a reaction vessel containing reticulated foam, provided conversion rates of the rapeseed oil to the desired ester mixture of more than 20% greater than the reaction when carried out in supercritical reaction vessel without a porous structure under the same conditions of temperature and pressure.

### EXAMPLE 2

### Example 2: Effects of Porous Structure on Esterification Conversion Rate in a Vessel

This experiment was conducted to demonstrate the difference in conversion rates for transesterification reactions occurring in a reactor vessel having a low length to diameter ratio, with and without inclusion of a porous structure.

The starting materials used for the reaction mixture was virgin canola oil as the lipid feedstock (free fatty acid content of 0.13%, as oleic acid, determined by NaOH titration) and anhydrous ethanol was employed as the alcohol reactant. No co-solvents were used.

The reaction vessel consisted of a 316 Stainless steel cylinder, 30 cm in length, with an inside diameter of 1.9 cm. The alcohol and oil were pumped via separate channels of an Eldex high pressure HPLC pump through sections of 3 mm stainless steel tubing through a condensing fluid heat exchanger, then brought into contact through a piping “tee” before entering the cylindrical reactor. The reactor was tested in an “empty” configuration, without a porous structure, as well as in a configuration whereby a porous aluminum oxide foam (40 pore per cm, Selee Corp) was fitted to the inside of the reactor vessel, completely filling the vessel.

The reactants were preheated to approximately 260° C. and were held at this temperature in the reaction vessel as well, for the duration of the reaction. The ratio of alcohol to oil was set by a flow rate of approximately 40 to 1 as the molar ratio. A pressure of 21 mPa was maintained in the reactor by means of a back pressure relief valve. Upon exiting the valve, the reaction mixture was cooled by transit through a coil of 3 mm stainless steel tubing immersed in a water bath, then collected. The alcohol was removed by means of a rotary evaporator (20 mm Hg, 90° C. water bath) and a 0.1 ml sample of the residue was silated and analyzed by means of a Shimadzu FIDGC chromatograph system for determination of fatty acid ethyl ester content.

The relative integrated chromatograph response for the ethyl ester peak area, as a percentage of total output response taken in relation to unit reactor residence time, is presented in Table 1. This presentation was chosen due to the study being conducted at constant total flow rate, whereby the residence time for the reaction differed in relation to the void volume of the porous material employed in the reactor.

TABLE 1
Output of ethyl ester from an esterification reaction

| | Ester Output | | Relative Ester |
|---|---|---|---|
| Reactor | Relative | Residence | Output per |
| Mode | Rate | Time | Minute |
| Reactor Tube | 10.43 | 7.4 min | 1.41 |
| Without Foam | | | |
| Reactor Tube | 20.15 | 6.1 min | 3.30 |
| With Alumina | | | |
| Foam | | | |

This experiment clearly demonstrates the effectiveness of the addition of the aluminum oxide foam to the reaction vessel in that the relative rate of ester formation was well over twice as fast with incorporation of the porous structure compared to the reactor without the porous alumina foam.

Although specific embodiments have been illustrated and described herein, it will be appreciated by those of ordinary skill in the art that any arrangement that is calculated to achieve the same purpose may be substituted for the specific embodiments shown. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description.

What is claimed is:

1. A vessel for producing fatty acid esters comprising:
a sealable input;
a body that surrounds an interior, wherein said body is robust at a temperature greater than 200° C. and a pressure greater than 5 mPa;
a porous structure that comprises one or more of the following: a transition metal, a transition metal oxide or silicate, or an oxide or silicate of aluminum, silicon, magnesium, or calcium, wherein the porous structure occupies about more than half of the volume of said interior; and
a sealable output,
wherein an alcohol and a lipid-containing substance enter the vessel through said input and wherein glycerol and fatty acid esters exit the vessel through said output.

2. The vessel of claim 1 further comprising a regulated heating system for maintaining said temperature greater than 200° C.

3. The vessel of claim 2, wherein said temperature is maintained near or above the supercritical temperature of the reactant mixture.

4. The vessel of claim 1 further comprising a system of pumps, tubing and pressure regulators for maintaining said pressure greater than 5 mPa.

5. The vessel of claim 4, wherein said regulator is a pressure regulating valve.

6. The vessel of claim 1, further comprising a system for flow control of the substances entering and exiting the vessel.

7. The vessel of claim 1, wherein said porous structure is reticulated foam.

8. The vessel of claim 1, wherein said porous structure is selected from the group consisting of: mesh materials, foam, or foam like structures consisting of aggregations of hollow fibers, fibers, sponges, granules, spheres

9. The vessel of claim 1, wherein said transition metal or transition metal oxide or silicate, or an oxide or silicate of zirconium, titanium, manganese, or nickel.

10. The vessel of claim 1, wherein a co-solvent enters the vessel through the input, either alone or in combination with the lipid substance and alcohol.

11. The vessel of claim 10, wherein said co-solvent is carbon dioxide, nitrous oxide, sulfur dioxide, sulfur hexafluoride, an ether, and ester, a dialkyl carbonate, a C1-C12 alkane, or a halogenated compound.

12. The vessel of claim 10, wherein said pressure is maintained near or above a supercritical pressure of said co-solvent.

13. The vessel of claim 1, wherein said pressure is maintained near or above a supercritical pressure of said alcohol.

14. The vessel of claim 1, wherein said vessel further comprises a catalyst.

15. The vessel of claim 14, wherein said catalyst is a transition metal, a transition metal oxide or silicate, or an oxide or silicate of aluminum, silicon, magnesium, or calcium.

16. The vessel of claim 15, wherein said transition metal oxide is selected from the group consisting of nickel oxide, titanium oxide, zirconium oxide, and manganese oxide.

17. The vessel of claim 14, wherein said porous structure comprises said catalyst.

18. The vessel of claim 14, wherein said catalyst enters the vessel through said input.

19. The vessel of claim 1, wherein said lipid-containing substance is a fatty acid or a fatty acid ester.

20. The vessel of claim 1, wherein said lipid-containing substance is a waste oil, vegetable oil, animal oil, or animal fat.

21. The vessel of claim 1, wherein the body is cylindrical in shape.

22. The vessel of claim 21, wherein the body is about 10-2000 cm in length, and has an inner diameter of about 1-200 cm.

23. The vessel of claim 21, wherein the body is about 30-200 cm inches in length and has an inner diameter of about 8 to 20 cm.

24. A method of acquiring fatty acid esters comprising:
introducing an alcohol and a lipid-containing substance into a vessel, with or without a co-solvent, wherein the vessel is at least 2 cm in inner diameter and wherein the length-to-width ratio of the vessel is less than 20 to 1;
maintaining said vessel at or near the supercritical conditions of said reactant mixture, wherein said supercritical conditions react the alcohol and lipid-containing substance to form glycerol and fatty acid esters; and
acquiring said fatty acid esters.

25. A method of producing fatty acid esters comprising:
reacting an lipid-containing substance with an alcohol, with or without a co-solvent, in a reaction vessel under near critical or supercritical reaction conditions, wherein said reaction vessel comprises:
a sealable input;
a body that surrounds an interior, wherein said body is robust at a temperature greater than 200° C. and a pressure greater than 5 mPa;
a porous structure that comprises a transition metal, wherein the porous structure occupies more than half of said interior; and
a sealable output,
wherein an alcohol and a lipid-containing substance enter the vessel through said input and wherein glycerol and fatty acid esters exit the vessel through said output; and
producing fatty acid esters from substances exiting the output of the vessel.
